(19) United States
(12) Patent Application Publication
(10) Pub. No.: US 2012/0098756 A1
(43) Pub. Date: Apr. 26, 2012

(54) TOUCH PANEL

(75) Inventors: CHIUNG-CHI LIN, Taipei City (TW); CHING-YI LIN, Taipei City (TW)

(73) Assignee: FLYTECH TECHNOLOGY CO., LTD., TAIPEI CITY (TW)

(21) Appl. No.: 12/911,883

(22) Filed: Oct. 26, 2010

(51) Int. Cl. G06F 3/041

(52) U.S. Cl. 345/173

(57) ABSTRACT

A touch panel is provided. The touch panel comprises a frame, a touch pad module, a pad and a film. The frame has a compartment for receiving the touch pad module. The pad is disposed between the frame and the touch pad module in the compartment. Wherein, the frame, the touch pad module and the pad substantially at the same horizontals so that the film can be stacked onto the frame, the pad and the touch pad module flatly.

### BACKGROUND OF THE INVENTION

1. Field of the Invention

The present invention relates to a touch panel; in particular, the invention relates to a touch panel with a flat surface.

2. Description of the Related Art

With the development of science and technology, high-tech products have improved interactivities with users. For example, in the modern thin display sector, improved interactivity means that users can control the display directly by touching a touch panel thereof instead of through traditional peripheral devices such as keyboards or mice.

As shown in FIG. 1, the touch panel 1 comprises a frame 11, a touch pad module 12, a display device 14 and a film 15, wherein the film 15 is stacked onto the frame 11 and the touch pad module 12. Users can touch the film 15 by fingers or touch pens to make the electrode conducted so as to generate a variation of voltage. Then, sensors may receive the signal of variation of voltage and then calculating the exact touching position. Whereas, during the manufacturing process, there is inevitably a gap between the touch pad module 12 and the frame 11 despite the touch pad module 12 disposed in a compartment defined by the frame 11. As a result, if the touch pad module 12 is used for a prolong period of time, the film 15 stacked onto the frame 11 and the touch pad module 12 may sack into the gap between the frame 11 and the touch pad module 12. Thus, the film 15 meets a recessing condition which leads to the unsightly appearance so that the people's desire to purchase can't be inspired. Furthermore, the film 15 trapping into the gap may vary the whole structure which leads to the sensors may do an incorrect reaction.

Thus, many manufacturers in this industry have made efforts to improve the design of the film 15. The solution by far is to broaden the length and width of a conducting glass (not shown), with this arrangement, the conducting glass may be stacked onto the frame 11 firmly by its own strength to prevent the film 15 trapping into the gap. Unfortunately, a bottleneck in terms of the manufacturing process still exists because it is hard to chamfer the conducting glass and much cost.

In view of this, it is important to provide a touch panel with a flat surface. Based on research, the inventor proposes the present invention to address the above issues.

### SUMMARY OF THE INVENTION

The object of the instant disclosure is to provide a touch panel having a pad member disposed between a frame unit and a touch pad module to fill in the gap between the frame unit and the touch pad module, thus preventing the flattening the surface of the touch panel.

The touch panel of the present invention comprises a frame, a touch pad module, a pad and a film. The frame has a compartment for receiving the touch pad module. The frame comprises a first upper surface, the touch pad module comprises a second upper surface and the pad comprises a third upper surface. The pad is disposed between the frame and the touch pad module in the compartment. Wherein, the first upper surface, the second upper surface and the third upper surface are substantially at the same horizontals so that the film can be stacked onto the frame, the pad and the touch pad module flatly.

The instant disclosure has following benefits: due to the pad is disposed between the frame and the touch pad module so that the film stacked onto the frame and the touch pad module may be prevented from being trapping into the gap and a flat surface of the touch panel may be presented.

In order to further appreciate the characteristics and technical contents of the present invention, references are hereunder made to the detailed descriptions and appended drawings in connection with the present invention. However, the appended drawings are merely shown for exemplary purposes, rather than being used to restrict the scope of the present invention.

### BRIEF DESCRIPTION OF THE DRAWINGS

FIG. 1 is a sectional view of a conventional touch panel;

FIG. 2 shows a schematic perspective view of the touch panel of the present invention;

FIG. 3A shows a sectional view along line A-A of FIG. 2 of the present invention; and

FIG. 3B shows a sectional view along line B-B of FIG. 2 of the present invention.

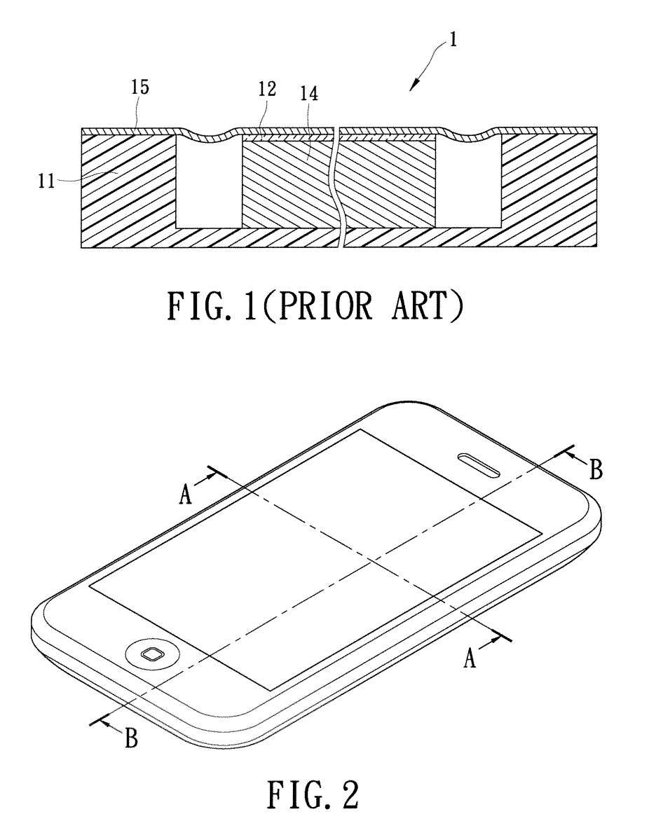

### DETAILED DESCRIPTION OF THE PREFERRED EMBODIMENT

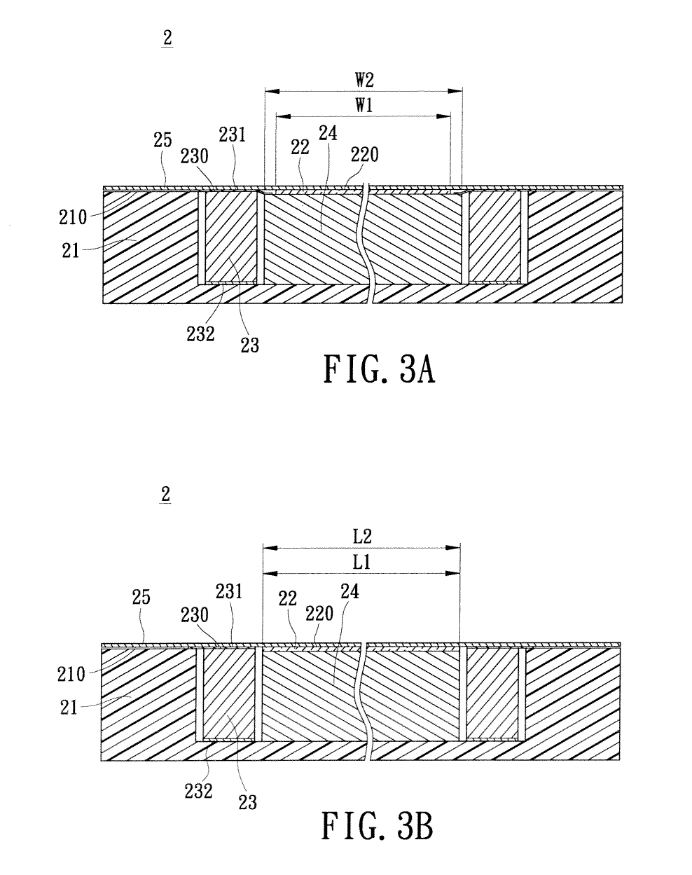

Referring to FIG. 2 to FIG. 3B, which shows the touch panel of the instant disclosure. Wherein, FIG. 2 is a schematic perspective view of the touch panel, FIG. 3A is a sectional view along line A-A of FIG. 2, and FIG. 3B is a sectional view along line B-B of FIG. 2. It should be noted herein, the figures shown here is used to distinctly disclose the relation between each element, not used to restrict the disclosure.

As shown in FIG. 3A, the touch panel 2 comprises a frame unit 21, a pad member 23, a touch pad module 22, and a film 25. The frame 21 has an interior compartment and comprises a first upper surface 210. Further, the touch pad module 22 comprises a second upper surface 220, and the pad 23 comprises a third upper surface 230. Wherein, the pad 23, the frame 21 and the touch pad module 22 are received in the compartment, and the pad 23 is disposed between the frame 21 and the touch pad module 22. Further, the film 25 is adapted to be stacked onto the first upper surface 210, the second upper surface 220 and the third upper surface 230. Preferably, the first upper surface 210, the second upper surface 220 and the third upper surface 230 are substantially at the same horizontals. The film 25 could be flatly disposed above the frame 21, touch pad module 22 and the pad 23 due to film 25 could be support by the pad 23 which is disposed between the frame 21 and the touch pad module 22. Compare to the related art, the touch panel 2 of the instant disclosure is without the disadvantage of the surface of the touch panel trapped into so as to benefit to flatten the surface of the touch panel.

Referring to FIG. 3A, wherein the touch panel 2 further comprises a display device 24 which is adjacent to a lateral surface opposite to the second upper surface 220 of the touch pad module 22. In other words, the display device 24 is disposed between the frame 21 and the touch pad module 22. Furthermore, the pad 23 further comprises a first tape 231 and a second tape 232 opposite to the first tape 231. The first tape 231 adheres upward onto the film 25 and adheres downwards onto the display device 24, pad 23 and the frame 21. The first tape 231 has the thickness less than 0.5 mm so that the film 25 stacked onto the tape 231 still can be flatly disposed. The second tape 232 adheres upward onto the pad 23 and adheres downward onto the frame 21 to fix the pad 23 onto the frame 21. Wherein, the length of first tape 231 and the length of the second tape 232 are not restricted herein. Accordingly, the first tape 231 may adhere onto the pad 23 and frame 21, adhere onto the pad 23 and the display device 24 or adhere onto the pad 23 only. People skilled in this field may proceed with such disposition without departing from the characteristics thereof and which is not to be limited herein.

Furthermore, the touch pad module 2 further comprises a conducting glass (not shown) disposed on a lateral of the touch pad module 22 and adjacent to the display device 24. Therefore, the conducting glass may electrode-conducted and generate a variation of the voltage when the user touches the film 25. Wherein, the length and the width of the conducting glass generally equal to the length and the width of the touch pad module 22. In this embodiment, the width W1 of the touch pad module 22 may be less than the width W2 of the display device 24 (as shown in FIG. 3A) and the length L1 of the touch pad module 22 may be less than the length L2 of the display device 24 (not shown); or the length L1 of the touch pad module 22 may equal to the length L2 (as shown in FIG. 3B) of the display device 24 and the width W1 of the touch pad module 22 may equal to the width W2 of the display device 24 (not shown). Accordingly, the touch pad module 22 of the touch panel 2 of the instant disclosure may take account of reducing the use of the material corresponding to different conditions, thereby reducing overhead costs.

In more detail, the pad 23 may be made of a material selected from the group consisting of polypropylene, polyethylene, polystyrene, polyvinyl chloride, polyoxymethylene, polycarbonate, acrylonitrile butadiene styrene, nylon, ethylene-vinyl acetate (EVA), rubber, and a combination thereof, but not restricted in above materials. Wherein, a difference in thermal expansion coefficient between the pad and the display device is between −30% to 30%. Therefore, the film 25 may be disposed flatly without undulate during a period of use time.

As described above, the touch panel 2 of the instant disclosure further comprising a pad 23 disposed between the frame 21 and the touch pad module 22, and adhered onto the film 25 by a first tape. Therefore, the film 25 can be disposed flatly so that the touch panel 2 may be with a flat surface.

The descriptions illustrated supra set forth simply the preferred embodiments of the present invention; however, the characteristics of the present invention are by no means restricted thereto. All changes, alternations, or modifications conveniently considered by those skilled in the art are deemed to be encompassed within the scope of the present invention delineated by the following claims.

What is claimed is:

1. A touch panel, comprising::
a frame unit having a compartment partially exposedly disposed on a first upper surface thereon;
a touch pad module disposed in the compartment having a second upper surface, the touch pad module at least partially visually exposed from the compartment of the frame unit;
a pad member disposed in the compartment between the frame unit and the touch pad module, the pad member having a third upper being between the first upper surface of the frame unit and the second upper surface of the touch pad module; and
a film disposed on the first upper surface of the frame unit over the second upper surface of the touch pad module and the third upper surface of the pad member.

2. The touch panel as claimed in claim 1, wherein the first upper surface, the second upper surface and the third upper surface are arranged substantially on the same horizontal level.

3. The touch panel as claimed in claim 2, further comprising a display device adjacent to a lateral surface of the touch pad module opposite to the second upper surface.

4. The touch panel as claimed in claim 3, wherein the pad further comprises a first tape and a second tape disposed on the opposite ends of the pad separately.

5. The touch panel as claimed in claim 4, wherein the first tape adheres to the touch pad module upward, and adhered onto the display device, the pad member, and the frame unit downward.

6. The touch panel as claimed in claim 5, wherein the second tape adheres onto the pad member upward and adhered onto the frame unit downward.

7. The touch panel as claimed in claim 6, wherein the touch pad module further comprises a conducting glass stacked onto the display device.

8. The touch panel as claimed in claim 7, wherein the width of the touch pad module is less than the width of the display device.

9. The touch panel as claimed in claim 7, wherein width of the touch pad module is equal to the width of the display device.

10. The touch panel as claimed in claim 7, wherein the difference in thermal expansion coefficient between the pad and the display device is between −30% to 30%.
